(19) United States
(12) Patent Application Publication
(10) Pub. No.: US 2024/0376858 A1
(43) Pub. Date: Nov. 14, 2024

(54) WAVE ENERGY POWER GENERATION DEVICE AND POWER GENERATION METHOD

(71) Applicants: Jianyuan CHEN, Guangzhou (CN); Jiazhi CHEN, Guangzhou (CN)

(72) Inventors: Jianyuan CHEN, Guangzhou (CN); Jiazhi CHEN, Guangzhou (CN)

(21) Appl. No.: 18/661,598

(22) Filed: May 11, 2024

Related U.S. Application Data
(63) Continuation of application No. PCT/CN2022/124764, filed on Oct. 12, 2022.

(30) Foreign Application Priority Data
Jan. 12, 2022 (CN) 202210034261.X

(51) Int. Cl. F03B 13/22

(52) U.S. Cl. CPC F03B 13/22; F05B 2220/705; F05B 2220/706; F05B 2240/93; F05B 2260/4031

(57) ABSTRACT

Provided is a wave energy power generation device, comprising a working platform, and a wave energy conversion mechanism, a wave energy storage mechanism and a wave energy power generation mechanism, which are arranged on the working platform. By means of the structures, such as a buoyancy tank, a lever, a gear set and a flywheel, the wave energy conversion mechanism converts wave energy, which is generated by wave fluctuation, into mechanical energy ensuring the continuous rotation of the flywheel. The wave energy storage mechanism, by means of compressed gas, collects and stores the wave energy.

### TECHNICAL FIELD

The present invention relates to the technical field of energy utilization, in particular to a wave energy power generation device.

### BACKGROUND

The ocean accounts for 70% of the earth surface area and concentrates 97% of the earth water. Ocean waves have huge energy. As a clean energy source, wave energy has broad commercial prospects and is the focus of ocean energy research and development in various countries. Although human beings have been exploring wave power generation for a long history, wave power generation has not been as widely used in commercialization as thermal power and nuclear power. The reason is that the wave is an unstable energy source, which only ripples slowly when it is calm, and becomes monstrous when it encounters a strong wind. Hence, it is impossible to realize stable conversion of energy. At present, wave grades are divided into 9 grades. Wave grades suitable for utilization are about Grade 3 to 5. At this time, the wave peak range is 0.5 m to 5 m. Even within this range, there is a gap of nearly ten times between the maximum value and the minimum value of the wave. It is very difficult to achieve peak-stable power generation under such a large gap. Hence, so far, the cost of wave power generation is much higher than that of other power generation modes. A wave power generation solution and method suitable for industrial development have not been found.

Despite the huge wave energy, so far, existing wave energy power generation devices cannot achieve low-cost high-power power generation, mainly because the energy utilization rate of the existing wave energy power generation devices is low and energy conversion mechanisms cannot provide long-term and stable energy supply to power generation mechanisms.

### SUMMARY

In order to solve the above technical problems, a purpose of the present invention is to provide a wave energy power generation device, which has the advantages of a high energy utilization rate, stable and long-term power generation effect and the like.

Based on this, the present invention provides a wave energy power generation device, which comprises a working platform, and a wave energy conversion mechanism, a wave energy storage mechanism and a wave energy power generation mechanism, which are arranged on the working platform.

The wave energy conversion mechanism comprises an energy conversion assembly and a conversion assembly.

The energy conversion assembly comprises a buoyancy tank, a lever and a first bracket, wherein the buoyancy tank is arranged on a sea surface and is hinged with one end of the lever; a fulcrum of the lever is hinged with the first bracket; the other end of the lever is provided with an arc-shaped swing head; and the arc surface circle center of the swing head coincides with the fulcrum of the lever.

The conversion assembly comprises an input shaft, an output shaft and a transition shaft; the input shaft is sleeved with an input gear; the output shaft is sleeved with a first unidirectional gear, a second unidirectional gear, a flywheel and an output gear; the transition shaft is sleeved with a transition gear set; the input gear is in transmission connection with the swing head through a transmission assembly; the input gear is in transmission connection with the first unidirectional gear; the input gear is in transmission connection with the second unidirectional gear through the transition gear set; the first unidirectional gear and the second unidirectional gear can drive the output shaft to rotate under drive of the input gear, and drive the output shaft to rotate in the same direction; and the output gear and the flywheel can rotate together with the output shaft.

The wave energy storage mechanism comprises an air compressor and a high-pressure gas storage tank; the air compressor is in transmission connection with the output gear through a connecting assembly; and the air compressor is connected to the high-pressure gas storage tank through a ventilation pipe.

The wave energy power generation mechanism comprises an air turbine and a generator; the air turbine is connected to the high-pressure gas storage tank through the ventilation pipe; and the air turbine is in transmission connection with the generator.

In some embodiments of the present application, the buoyancy tank is hinged with the lever through a first connecting rod; and the buoyancy tank is hinged with the first bracket through a second connecting rod.

In some embodiments of the present application, the energy conversion assembly further comprises a sliding rail arranged on the working platform and an electric hoist arranged on the sliding rail, and the electric hoist is connected to the first connecting rod through a steel wire rope.

In some embodiments of the present application, the transmission assembly comprises a first sprocket, a second sprocket, a first driving wheel and a first driven wheel; the first sprocket is in transmission connection with the second sprocket through a chain; two ends of the chain are crossed and then arranged at two ends of an arc top of the swing head respectively; the first driving wheel and the first sprocket are arranged on the same rotating shaft and can rotate under drive of the first sprocket; the first driven wheel is in transmission connection with the first driving wheel through a first conveyor belt; and the first driven wheel is in transmission connection with the input gear.

In some embodiments of the present application, a rack is arranged on the arc surface of the swing head; the transmission assembly comprises a meshing gear, a first driving wheel and a first driven wheel; the meshing gear is meshed with the rack; the first driving wheel and the meshing gear are arranged on the same rotating shaft and can rotate under drive of the meshing gear; the first driven wheel is in transmission connection with the first driving wheel through a first conveyor belt; and the first driven wheel is in transmission connection with the input gear.

In some embodiments of the present application, the conversion assembly is provided with a speed-increasing gear set; the speed-increasing gear set comprises a first speed-increasing gear and a second speed-increasing gear meshed with each other; the first speed-increasing gear is in transmission connection with the transmission assembly; the second speed-increasing gear is in transmission connection with the input gear; and the diameter of the first speed-increasing gear is larger than that of the second speed-increasing gear.

In some embodiments of the present application, the conversion assembly is provided with a reduction gear set; the reduction gear set comprises a first reduction gear and a second reduction gear meshed with each other; the first reduction gear is in transmission connection with the output gear; the second reduction gear is in transmission connection with the connecting assembly; and the diameter of the first reduction gear is smaller than that of the second reduction gear.

In some embodiments of the present application, the connecting assembly comprises a second driving wheel and a second driven wheel; the second driving wheel is in transmission connection with the output gear; and the second driven wheel is sleeved on an output shaft of the air compressor and is in transmission connection with the second driving wheel through a second conveyor belt.

In some embodiments of the present application, the wave energy storage mechanism further comprises an air filter connected to the air compressor.

In some embodiments of the present application, the high-pressure gas storage tank comprises a primary gas storage tank, a secondary gas storage tank and a tertiary gas storage tank which are sequentially arranged.

Another purpose of the present invention is to provide a wave energy power generation method, which comprises the following steps:
S1: arranging a buoyancy tank on a sea surface; floating, by the buoyancy tank, up and down with wave fluctuation; driving a lever to rotate around a fulcrum by floating of the buoyancy tank; and swinging, by a swing head at the other end of the lever, up and down with rotation of the lever;
S2: driving a first driving wheel of a transmission assembly to rotate by swing of the swing head; and driving a first driven wheel to rotate by rotation of the first driving wheel;
S3: driving an input gear and an output gear to rotate by rotation of the first driven wheel; and driving, by rotation of the input gear and the output gear, a flywheel to rotate through a unidirectional gear set;
S4: driving a second driving wheel to rotate by rotation of the flywheel; and driving a second driven wheel to rotate by rotation of the second driving wheel;
S5: driving an air compressor to operate by rotation of the second driven wheel; compressing air; and transmitting the compressed high-pressure gas to a high-pressure gas storage tank through a ventilation pipe;
S6: transporting the high-pressure gas storage tank to an air turbine through the ventilation pipe to drive the air turbine to operate; and driving, by the operation of the air turbine, a generator to operate to complete power generation.

Embodiments of the present invention provide a wave energy power generation device. Compared with the prior art, the device has the beneficial effects that:

The power generation device of the present invention comprises the working platform, and the wave energy conversion mechanism, the wave energy storage mechanism and the wave energy power generation mechanism, which are arranged on the working platform. These mechanisms can be combined by different structural deformation, increase, decrease and substitution according to design requirements, so as to achieve the best required energy conversion and achieve different use purposes. Specifically: in the device structural combination, by means of the structures, such as the buoyancy tank, the lever, the gear set and the flywheel, the wave energy conversion mechanism converts wave energy, which is generated by wave fluctuation, into mechanical energy ensuring the continuous rotation of the flywheel; the wave energy storage mechanism, by means of compressed gas, collects and stores the mechanical energy of the flywheel; and the wave energy power generation mechanism realizes power generation under drive of the compressed gas. The wave energy power generation device realizes the effective utilization of the wave energy, and is ingenious in structural design. According to the device designed by this method, by means of the provision of the buoyancy tank and the lever, the energy generated by the heave motion of the buoyancy tank due to up-and-down floating can be effectively collected; rolling and pitching of the buoyancy tank are effectively reduced; the energy loss caused by the rolling and pitching of the buoyancy tank is avoided; and the energy conversion efficiency is improved. Structures such as the gear set and the flywheel convert the wave energy generated by the wave fluctuation into the mechanical energy to ensure the continuous high-speed rotation of the flywheel. The wave energy storage mechanism converts the generated mechanical energy into the internal energy of high-pressure gas, and then releases the high-pressure gas to drive the air turbine and the generator to operate, such that the generator can be persistently and stably supplied with energy, thereby ensuring the stable operation of the generator. The device can be used alone or combined in multiple sets to form a modular unit according to use requirements, which can be miniaturized or enlarged, and has a wide application range. The device can be designed into various kinds of power generation equipment according to needs, and has long-term benefits by one-time investment.

The present invention further provides a wave energy power generation method based on the wave energy power generation device, which realizes the effective utilization of wave energy and has the advantages of stable power generation effects, easy popularization and the like.

### DESCRIPTION OF DRAWINGS

FIG. 1 is a schematic diagram of a wave energy power generation device according to an embodiment of the present invention;

FIG. 2 is a first schematic diagram of a wave energy conversion mechanism according to an embodiment of the present invention;

FIG. 3 is a second schematic diagram of a wave energy conversion mechanism according to an embodiment of the present invention;

FIG. 4 is a schematic diagram of connection between an energy conversion assembly and a transmission assembly according to an embodiment;

FIG. 5 is a schematic diagram of connection between an energy conversion assembly and a transmission assembly according to another embodiment;

FIG. 6 is a schematic diagram of gear arrangement of a conversion assembly according to an embodiment of the present invention;

FIG. 7 is a schematic diagram of forward rotation of a conversion assembly according to an embodiment of the present invention;

FIG. 8 is a schematic diagram of reverse rotation of a conversion assembly according to an embodiment of the present invention;

FIG. 9 is a schematic layout diagram of a multi-stage gas storage tank according to an embodiment of the present invention;

FIG. 10 is a structural schematic diagram of a wave energy power generation device according to an embodiment of the present invention when used for a navigation light;

FIG. 11 is a structural schematic diagram of a wave energy power generation device according to an embodiment of the present invention when arranged on a power generation ship;

FIG. 12 is a detailed view at A in FIG. 11.

In the figures: 1. working platform; 2. wave energy conversion mechanism; 21. energy conversion assembly; 211. buoyancy tank; 212. lever; 213. first bracket; 214. swing head; 214a. rack; 215. first connecting rod; 216. second connecting rod; 217. electric hoist; 218. steel wire rope; 219. sliding rail; 22. transmission assembly; 221. second bracket; 222. first sprocket; 223. second sprocket; 224. chain; 225. first driving wheel; 226. first driven wheel; 227. first tension wheel; 228. meshing gear; 23. conversion assembly; 231. input gear; 232. output gear; 233. flywheel; 234. first unidirectional gear; 235. second unidirectional gear; 236. transition gear; 237. first speed-increasing gear; 238. second speed-increasing gear; 239. first reduction gear; 239a. second reduction gear; 3. wave energy storage mechanism; 31. air compressor; 32. high-pressure gas storage tank; 321. primary gas storage tank; 322. secondary gas storage tank; 323. tertiary gas storage tank; 33. air filter; 34. second driving wheel; 35. second driven wheel; 36. second tension wheel; 37. pressure gauge; 38. pressure sensor; 4. wave energy power generation mechanism; 41. air turbine; 42. generator; 5. ventilation pipe; and 51. safety valve.

### DETAILED DESCRIPTION

Specific implementation modes of the present invention are further described in detail below in combination with the drawings and the embodiments. The following embodiments are used for illustrating the present invention, not used for limiting the scope of the present invention.

It should be understood that the terms “before” and “after” are used to describe various information in the present invention, but the information should not be limited to these terms which are only used to distinguish the same type of information from each other. For example, the “before” information can also be called “after” information, and the “after” information can also be called “before” information without departing from the scope of the present invention.

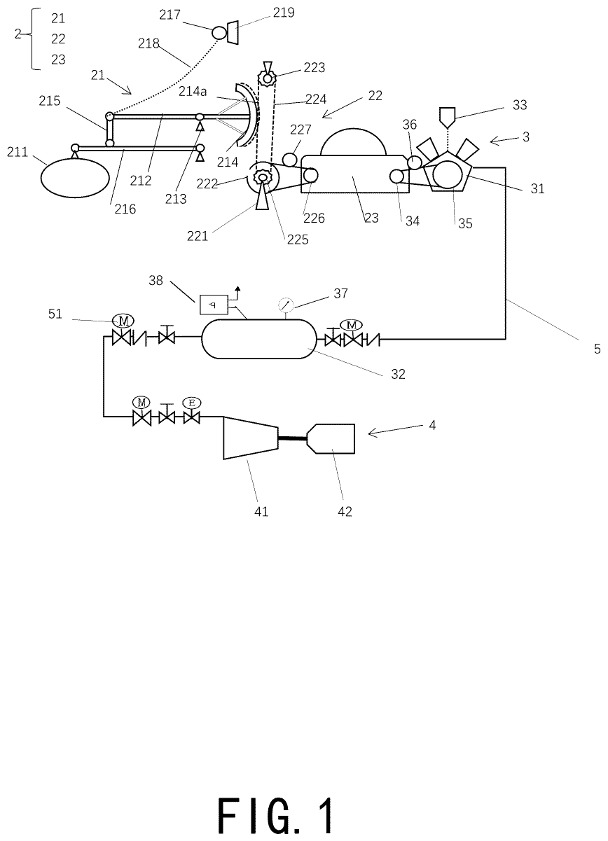

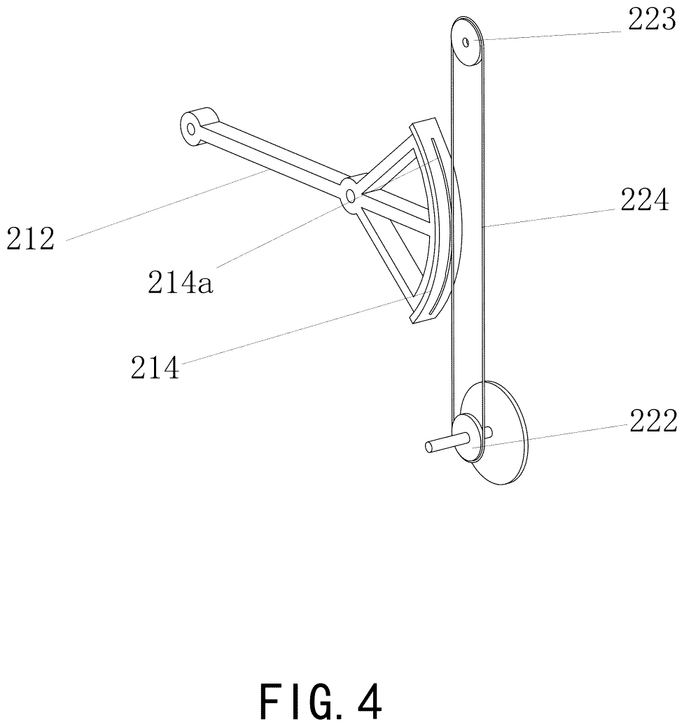

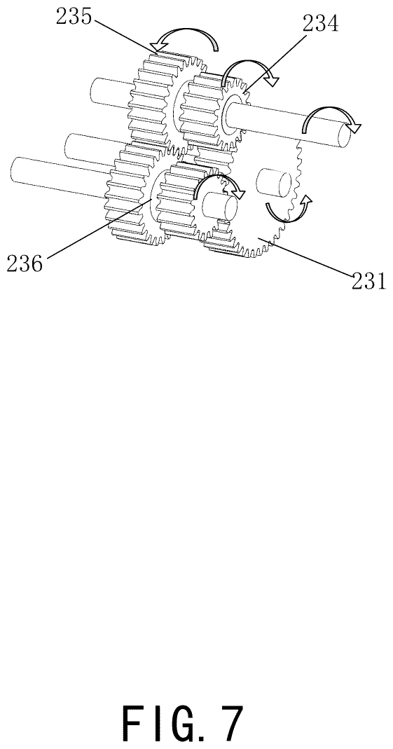

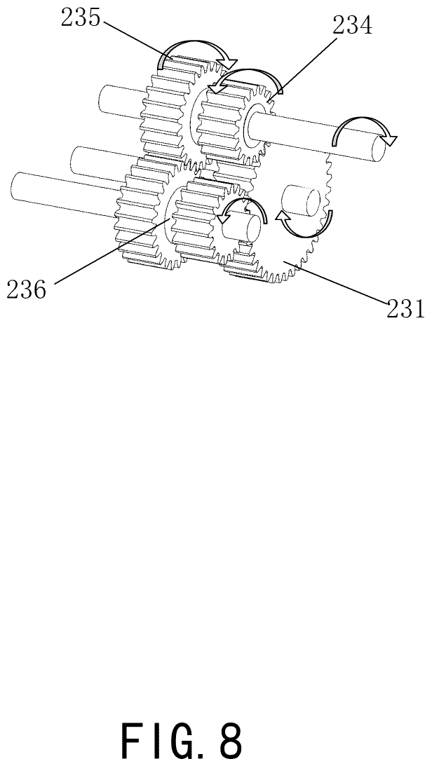

As shown in FIG. 1 to FIG. 12, an embodiment of the present invention provides a wave energy power generation device, which comprises a working platform 1, and a wave energy conversion mechanism 2, a wave energy storage mechanism 3 and a wave energy power generation mechanism 4, which are arranged on the working platform 1. Specifically, the wave energy conversion mechanism 2 comprises an energy conversion assembly 21, a transmission assembly 22 and a conversion assembly 23, wherein the energy conversion assembly 21 comprises a buoyancy tank 211, a first bracket 213 and a lever 212. The buoyancy tank 211 is arranged on a sea surface and hinged with one end of the lever 212; a fulcrum of the lever 212 is hinged with the first bracket 213; the other end of the lever 212, namely a resistance end, is provided with an arc-shaped swing head 214; and the arc surface circle center of the swing head 214 coincides with the fulcrum of the lever. In actual use, the buoyancy tank 211 is arranged on a sea level; the buoyancy tank 211 can ascend and descend in the vertical heave motion with the wave fluctuation; ascending and descending of the buoyancy tank 211 also make a power end of the lever 212 hinged with the buoyancy tank 211 ascend and descend; and the motion of the power end of the lever 212 drives the swing head 214 at the resistance end of the lever 212 to rotate around the fulcrum of the lever 212. In this way, the energy conversion assembly 21 converts the unstable wave energy into mechanical energy which makes the swing head 214 swing up and down.

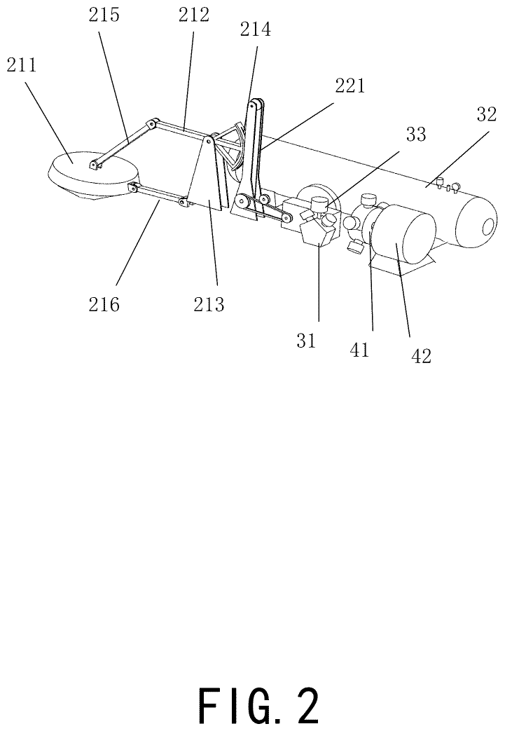

Further, the energy conversion assembly 21 is in transmission connection with the conversion assembly 23 through the transmission assembly 22. As shown in FIGS. 2 to 4, in some embodiments of the present application, the transmission assembly 22 comprises a first sprocket 222, a second sprocket 223, a first driving wheel 225 and a first driven wheel 226 arranged on a second bracket 221; the first sprocket 222 is in transmission connection with the second sprocket 223 through a chain 224; the chain 224 is connected to the swing head 214; when the chain 224 is fixedly connected to the swing head 214, two ends of the chain 224 are crossed and then fixed at two ends of an arc surface of the swing head 214 respectively; the first driving wheel 225 and the first sprocket 222 are arranged on the same rotating shaft and can rotate with the rotating shaft under drive of the first sprocket 222; the first driven wheel 226 is in transmission connection with the first driving wheel 225 through a first conveyor belt; and the first driven wheel 226 is in transmission connection with an input gear 231 of the conversion assembly 23. Based on the above structure, the motion of the power end of the lever 212 drives the swing head 214 at the resistance end of the lever 212 to rotate around the fulcrum of the lever 212; the chain 224 connected to the swing head 214 is driven to move by the swing head 214; the motion of the chain 224 drives the first sprocket 222 and the second sprocket 223 to rotate; the rotation of the first sprocket 222 drives the first driving wheel 225 to rotate; and the rotation of the first driving wheel 225 is transmitted to the first driven wheel 226 through the first conveyor belt and is transmitted to the conversion assembly 23 with the rotation of the first driven wheel 226 so as to realize energy transmission. At this time, the mechanical energy generated by the up-and-down swing of the lever 212 is converted into mechanical energy of reciprocating rotation by the transmission assembly 22.

It should be noted that when energy transmission is completed when each assembly is transmitted through the chain 224, there are also various structural forms. In other embodiments of the present application, the arc surface of the swing head 214 is fixedly connected to a rack 214a; and the chain 224 is meshed with the rack 214a. At this time, rotation of the rack 214a can also drive the chain 224 to move and then drive the first driving wheel to rotate.

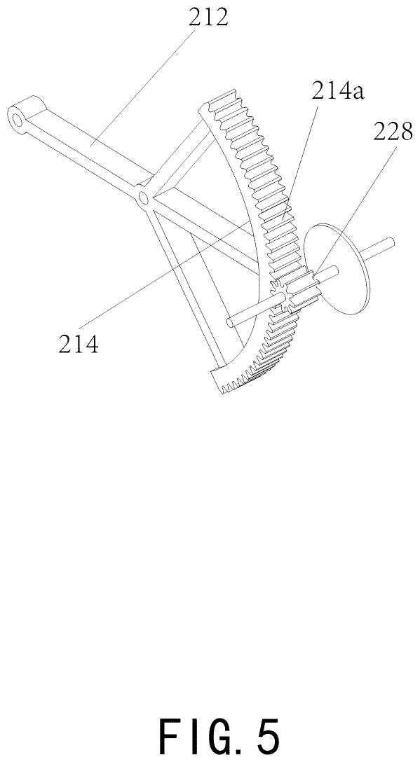

It should be noted that the higher the transmission power is, the larger the needed structure of the lever 212 is. In some embodiments, the chain 224, the first sprocket 222 and the second sprocket 223 are used as the transmission assembly, because the diameter of the swing head 214 at the resistance end of the lever 212 is sometimes too large or even more than 1 m during the high-power kinetic energy transmission conversion. However, in a device with low kinetic energy conversion requirements, there is no problem. Instead, the structure appears to be less compact when the chain and sprocket assemblies are used. Therefore, under the condition of realizing energy transmission, the transmission assembly 22 can obviously be set to other structural forms. Specifically, as shown in FIG. 5, in other embodiments of the present application, the arc surface of the swing head 214 is also provided with the rack 214a. The transmission assembly 22 comprises a meshing gear 228 arranged on the second bracket 221; the meshing gear 228 is meshed with the rack 214a; and the meshing gear 228 and the first driving wheel 225 are arranged on the same rotating shaft. Similar to the above-mentioned structure, in the embodiment, the meshing gear 228 is disposed to replace the first sprocket 222 and the second sprocket 223; and the rack 214a is disposed to replace the chain 224 or other structures, so that the first driving wheel 225 can be driven to rotate only by the rotation of the meshing gear 228, thereby realizing energy conversion and effective energy transmission.

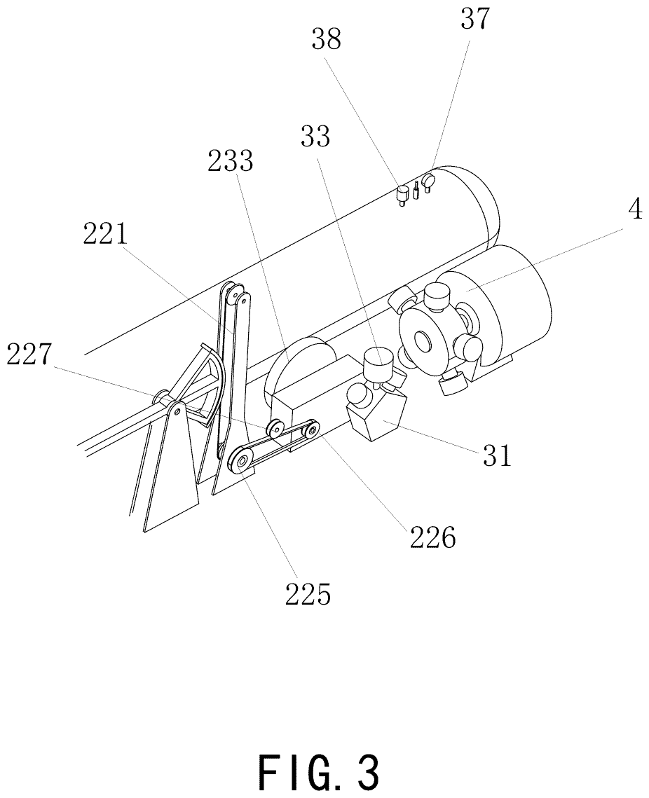

Further, as shown in FIG. 3, in some embodiments, the transmission assembly 22 further comprises a first tension wheel 227 for tensioning the first conveyor belt; and the first tension wheel 227 can adjust and control a tensioning degree of the first conveyor belt to adapt to the rotation of the first driving wheel 225 and the first driven wheel 226. The first tension wheel 227 is a tension device of the first conveyor belt. When the center distance of the first conveyor belt cannot be adjusted, the first conveyor belt can be tensioned by adjusting the first tension wheel 227 to realize the effective operation of the first driving wheel 225 and the first driven wheel 226. Of course, an operator can also realize idling of the first driving wheel 225 and the first driven wheel 226 by loosening the first tension wheel 227 to achieve a function of a clutch.

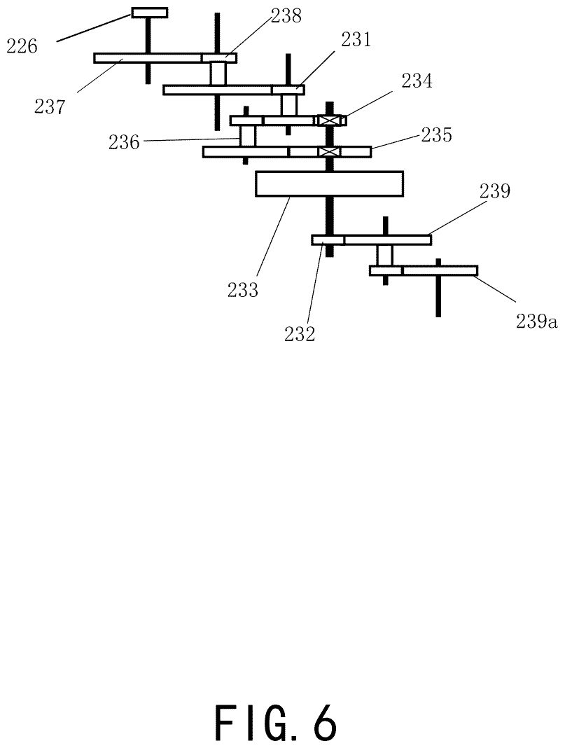

Obviously, the mechanical energy of reciprocating rotation cannot achieve stable and reliable power generation either. Hence, further, the wave energy conversion mechanism 2 further comprises a conversion assembly 23 disposed behind the transmission assembly 22. Specifically, as shown in FIGS. 6 to 8, the conversion assembly 23 comprises an input shaft, an output shaft and a transition shaft, wherein the input shaft is sleeved with an input gear 231; the output shaft is sleeved with an output gear 232, a flywheel 233, a first unidirectional gear 234 and a second unidirectional gear 235; the transition shaft is sleeved with a transition gear set 236; the input gear 231 is in transmission connection with the first driven wheel 226 of the transmission assembly 22; the input gear 231 is meshed with the first unidirectional gear 234; the input gear 231 is also meshed with the transition gear set 236; the transition gear set 236 is also meshed with the second unidirectional gear 235; the first unidirectional gear 234 and the second unidirectional gear 235 can drive the output shaft to rotate under drive of the input gear 231, and drive the output shaft to rotate in the same direction; and the output gear 232 and the flywheel 233 can rotate together with the output shaft. The mechanical energy of reciprocating rotation is transmitted to the input gear 231 through the first driven wheel 226; and the input gear 231 will rotate clockwise or counterclockwise with the rotation of the first driven wheel 226. Since the input gear 231 is meshed with the first unidirectional gear 234 and the second unidirectional gear 235 at the same time, the rotation of the input gear 231 will also drive the first unidirectional gear 234 and the second unidirectional gear 235 to rotate. It should be explained that the first unidirectional gear 234 and the second unidirectional gear 235 in the present application are unidirectional gears with the same and singular rotation direction. For the first unidirectional gear 234 and the second unidirectional gear 235 in the present application, they can drive the output shaft to rotate together when they rotate in a specified direction. When the rotation direction of the first unidirectional gear 234 and the second unidirectional gear 235 changes, the first unidirectional gear 234 and the second unidirectional gear 235 are idling due to their own structural settings. At this time, the rotation of the first unidirectional gear 234 and the second unidirectional gear 235 cannot drive the rotating shaft to rotate and will not affect the rotation of the output shaft. For example, if the rotation direction of the first unidirectional gear 234 and the second unidirectional gear 235 in the present application is defined to be clockwise, when the input gear 231 rotates clockwise, the first unidirectional gear 234 meshed therewith rotates counterclockwise and idles; and the first unidirectional gear 234 cannot affect the axle. However, the transition gear set 236 meshed with the input gear 231 rotates counterclockwise. The rotation of the transition gear set 236 drives the second unidirectional gear 235 meshed with the transition gear set 236 to rotate clockwise. At this time, the rotation of the second unidirectional gear 235 drives the flywheel 233 to rotate. When the input gear 231 rotates counterclockwise, the first unidirectional gear 234 meshed therewith rotates clockwise to drive the output shaft to rotate. At this time, the transition gear set 236 meshed with the input gear 231 rotates clockwise; and the second unidirectional gear 235 meshed with the transition gear set 236 rotates counterclockwise and idles, which also cannot affect the rotation of the output shaft. That is, no matter how the input gear 231 rotates, the output shaft will rotate clockwise under drive of the first unidirectional gear 234 or the second unidirectional gear 235; and the flywheel 233 and the output gear 232 arranged on the output shaft will rotate with the rotation of the output shaft. In other words, the mechanical energy of reciprocating rotation will be converted into mechanical energy of unidirectional rotation by the conversion assembly 23, which further improves stability of energy supply.

Obviously, the energy conversion of the wave energy power generation device in the present application has tended to be stable when it reaches the flywheel 233; and a relatively stable energy source can be provided to the wave energy power generation mechanism 4 through the rotation of the flywheel 233. However, the operator also notices that the flying wheel 233 rotating unidirectionally will also be limited by the up-and-down motion of the buoyancy tank. Specifically, when there are few waves at sea, the wave fluctuation degree is limited. At this time, it is impossible to ensure that the continuous rotation of the flying wheel 233 can be provided with enough power only by the up-and-down floating of the buoyancy tank 211. Therefore, in order to further improve the stability of energy, in some embodiments of the present application, as shown in FIGS. 1 to 3, the wave energy power generation device further comprises a wave energy storage mechanism 3. Specifically, the mechanism comprises an air compressor 31 and a high-pressure air storage tank 32. The air compressor 31 is in transmission connection with the output gear 232 through a connecting assembly; and the air compressor 31 is connected to the high-pressure air storage tank 32 through a ventilation pipe 5. Further, in the embodiment of the present invention, the connecting assembly comprises a second driving wheel 34 and a second driven wheel 35; the output gear 232 is in transmission connection with the second driving wheel 34; the second driven wheel 35 is in transmission connection with the second driving wheel 34 through a second conveyor belt; and the second driven wheel 35 is arranged on an output shaft of the air compressor 31. The output gear 232 outputs power to the second driving wheel 34 when the wave energy power generation device operates; the second driven wheel 35 is driven by the second driving wheel 34 to drive the air compressor 31 to operate; and the air compressor 31 continuously compresses air and transmits the compressed high-pressure gas to the high-pressure gas storage tank 32 through the ventilation pipe 5. In order to improve the tensioning effect, similar to the first driving wheel 225 and the first driven wheel 226, the connecting assembly also comprises a second tension wheel 36 for tensioning the second conveyor belt. The arrangement of the air compressor 31 and the high-pressure gas storage tank 32 converts the mechanical energy of unidirectional rotation into the internal energy of compressed gas to realize collection and storage of energy. The compressed gas stored in the high-pressure gas storage tank 32 can also be continuously output externally through the ventilation pipe 5 to realize long-term and stable output of the energy.

It can be found that the energy conversion assembly 21 in the present application makes the swing head 214 of the lever 212 take the fulcrum of the lever 212 as the axis through the fluctuation of the buoyancy tank 211, and generates the mechanical energy of swinging up and down. The transmission assembly 22 converts the mechanical energy of swinging up and down into mechanical energy of reciprocating rotation. The mechanical energy of reciprocating rotation is converted into the mechanical energy of unidirectional rotation till the conversion assembly 23, thereby realizing the stable power supply for the power generation structure. In the whole process, the energy conversion assembly 21 and the conversion assembly 23 play a key role in energy conversion; and the transmission assembly 22 often only plays the role of energy transmission. That is, in other embodiments of the present application, the wave energy power generation device has only the energy conversion assembly 21 and the conversion assembly 23; and this design can also realize effective conversion of wave energy. For this design, the rack 214a of the energy conversion assembly 21 is in transmission connection with the input gear 231 to realize effective connection between the energy conversion assembly 21 and the conversion assembly 23, thereby ensuring reasonable transmission of the energy.

Corresponding to the wave energy storage mechanism 3, the wave energy power generation mechanism 4 in the present application comprises an air turbine 41 and a generator 42. The air turbine 41 is also communicated with the high-pressure gas storage tank 32 through the ventilation pipe 5; and the generator 42 is in transmission connection with the air turbine 41. During use, the high-pressure gas storage tank 32 releases high-pressure gas to the air turbine 41; the air turbine 41 is driven by the high-pressure gas to rotate; and the rotation of the air turbine 41 further drives the generator 42 to operate, thereby realizing continuous and stable power generation. Of course, the air turbine 41 may also be adjusted to be a pneumatic motor in order to realize power generation of the generator 42. Further, the operator can also set other relay mechanisms to drive the operation of other structures with compressed gas to realize more functions.

In this way, the wave energy power generation device realizes the effective utilization of the wave energy, and is ingenious in structural design. By means of the provision of the buoyancy tank and the lever, the energy generated by the heave motion of the buoyancy tank due to up-and-down floating can be effectively collected; rolling and pitching of the buoyancy tank are effectively reduced; the energy loss caused by the rolling and pitching of the buoyancy tank is avoided; the energy conversion efficiency is improved; and the wave energy storage mechanism converts the generated mechanical energy into the internal energy of high-pressure gas, and then releases the high-pressure gas to drive the air turbine and the generator to operate, such that the generator can be persistently and stably supplied with energy, thereby ensuring the stable operation of the generator. The device can be used alone or combined in multiple sets to form a modular unit according to use requirements, which can be miniaturized or enlarged, and has a wide application range. The device can be designed into various kinds of power generation equipment according to needs, and has long-term benefits by one-time investment.

Optionally, as shown in FIG. 1, in some embodiments of the present application, the buoyancy tank 211 of the present application is hinged with the power end of the lever 212 through a first connecting rod 215; and at the same time, the buoyancy tank 211 is hinged with the bracket through a second connecting rod 216. The arrangement of the first connecting rod 215 and the second connecting rod 216 improves the stability of the buoyancy tank 211, optimizes the acting degree of the buoyancy tank 211 on the lever 212, and reduces the loss in energy transmission.

Further, the energy conversion assembly 21 further comprises a sliding rail 219 arranged on the working platform 1 and an electric hoist 217 arranged on the sliding rail 219; and the electric hoist 217 is fixedly connected to the first connecting rod 215 through a steel wire rope 218. The electric hoist 217 can slide on the sliding rail 219 to adjust the position of the first connecting rod 215. That is, the operator can pull the first connecting rod 215 through the steel wire rope 218 on the electric hoist 217 to control the upper lifting limit of the buoyancy tank 211. At the same time, the arrangement of the steel wire rope 218 can further improve connection between the buoyancy tank 211 and the working platform 1, avoid the buoyancy tank 211 from being detached in winds and waves, and improve the stability of the buoyancy tank 211.

The operator finds in actual use that the rotation speed of the first driven wheel 226 is limited. High-speed rotation of the flywheel 233 cannot be realized only by the rotation of the first driven wheel 226. In order to solve this technical problem, as shown in FIGS. 6 to 8, the conversion assembly 23 comprises a speed-increasing gear set for increasing an input rotation speed. Specifically, the speed-increasing gear set comprises a first speed-increasing gear 237 and a second speed-increasing gear 238 which are meshed with each other. In order to achieve the speed-increasing effect, the diameter of the first speed-increasing gear 237 is larger than that of the second speed-increasing gear 238; the first speed-increasing gear 237 is in transmission connection with the first driven wheel 226; the second speed-increasing gear 238 is meshed with the input gear 231; the rotation of the first driven wheel 226 drives the first speed-increasing gear 237 to rotate; the rotation of the first speed-increasing gear 237 further drives the second speed-increasing gear 238 to rotate; and the rotation of the second speed-increasing gear 238 drives the output gear 232 to complete the rotation. Since the diameter of the first speed-increasing gear 237 is larger than that of the second speed-increasing gear 238, the original rotation speed for rotation of a pinion driven by a gear wheel is improved, thereby realizing rotation speed increase of the flywheel 233.

Similarly, the conversion assembly 23 further comprises a reduction gear set for reducing the output rotation speed. Specifically, as shown in FIGS. 6 to 8, the reduction gear set comprises a first reduction gear 239 and a second reduction gear 239a which are meshed with each other. In order to achieve the reduction effect and then increase the torque, the diameter of the first reduction gear 239 is smaller than that of the second reduction gear 239a; the first reduction gear 239 is meshed with the output gear 232; the second reduction gear 239a is coaxially disposed with the second driving wheel 34; the rotation of the output gear 232 drives the first reduction gear 239 to rotate; the rotation of the first reduction gear 239 further drives the second reduction gear 239a to rotate; and the rotation of the second reduction gear 239a drives a pulley to complete the rotation. Since the diameter of the first reduction gear 239 is smaller than that of the second reduction gear 239a, the pinion drives the gear wheel to rotate, so that the original rotation speed is reduced, and thus the rotation speed of the second driving wheel 34 is reduced.

It should be noted that air contains a lot of impurities. If these gases are directly sucked by the air compressor 31 without being filtered, they will inevitably affect the normal use of the air compressor 31 and the high-pressure air storage tank, and even reduce the service life of various components in severe cases. Therefore, in order to avoid the above situation, as shown in FIGS. 2 and 3, the wave energy storage mechanism 3 further comprises an air filter 33 connected to the air compressor 31, wherein the air filter 33 can filter impurities in the air sucked by the air compressor, improve the quality of compressed gas, and ensure normal use of all components.

Further, for the high-pressure gas storage tanks 32 in the present application, in order to maximize the energy collection capacity of the wave energy storage mechanism, a plurality of high-pressure gas storage tanks 32 can be arranged; each high-pressure gas storage tank 32 is communicated with the air compressor through the ventilation pipe 5; the ventilation pipe 5 is provided with safety valves 51 for controlling gas circulation; and various types of safety valves 51 are disposed, including a regulating valve and a check valve.

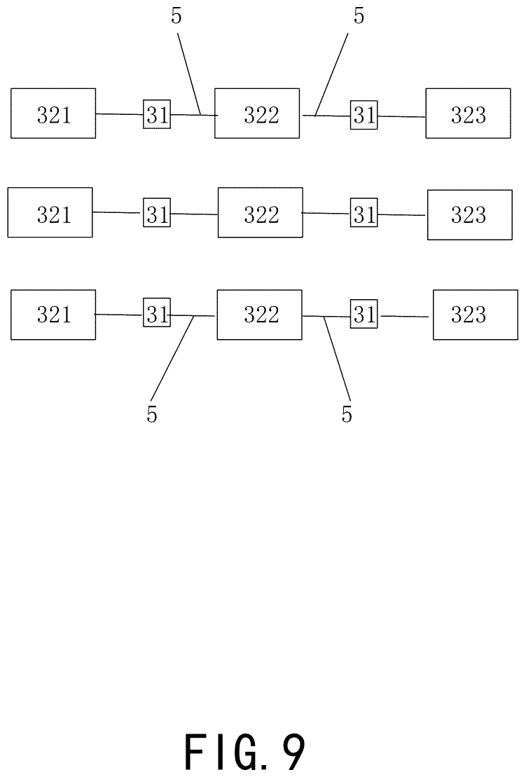

Obviously, the operation power of a single air compressor 31 is extremely limited; and the energy stored by the high-pressure gas only compressed once is very limited. Hence, in order to realize the energy carried by air per m³, the compressed gas can only be compressed again. Based on this, in some embodiments of the present application, the air compressor 31 and the high-pressure gas storage tank 32 are provided with a plurality of groups; and the groups are connected in turn through the ventilation pipe 5. Specifically, as shown in FIG. 9, in an embodiment of the present invention, there are three groups of air compressors and high-pressure gas storage tanks; and the high-pressure gas storage tank 32 is formed into a primary gas storage tank 321, a secondary gas storage tank 322 and a tertiary gas storage tank 323 which are sequentially arranged; the gas storage tanks at all levels are connected through the ventilation pipe 5; and the air compressor 31 is also arranged on the ventilation pipe 5 for connecting the gas storage tanks at all levels.

Further, in some embodiments of the present application, as shown in FIG. 3, the high-pressure gas storage tank 32 is provided with components such as a pressure gauge 37 and a pressure sensor 38. The operator can know the pressure situation in the high-pressure gas storage tank in time through the pressure gauge 37 and the pressure sensor 38 and make targeted adjustments to achieve pressure balance and stability and ensure the normal operation of the whole device.

Optionally, in some embodiments of the present application, the power generation mechanism of the wave energy power generation device further comprises a central control system (not shown in the diagram) electrically connected to the safety valves 51, the pressure sensor 38 and other structures. The central control system can receive information transmitted by sensing devices, analyze and process it, and then control related valves to open and close, so as to realize automatic operation of the whole device.

In addition, design forms of the working platform 1 in the present application are also various. Obviously, the arrangement of the working platform 1 needs to be confirmed according to the arrangement numbers and forms of the wave energy conversion mechanism 2, the wave energy storage mechanism 3 and the wave energy power generation mechanism 4, which can be integrated design or segmented arrangement. In some embodiments of the present application, the working platform 1 comprises an offshore platform (not shown in the diagram) located on the sea surface and an onshore platform (not shown in the diagram) located on a roadbed. Designers install the wave energy conversion mechanism 2 on the offshore platform, and the wave energy storage mechanism 3 and the wave energy power generation mechanism 4 on the onshore platform according to use requirements. Of course, all the mechanisms of the wave energy power generation device can be arranged on the offshore platform.

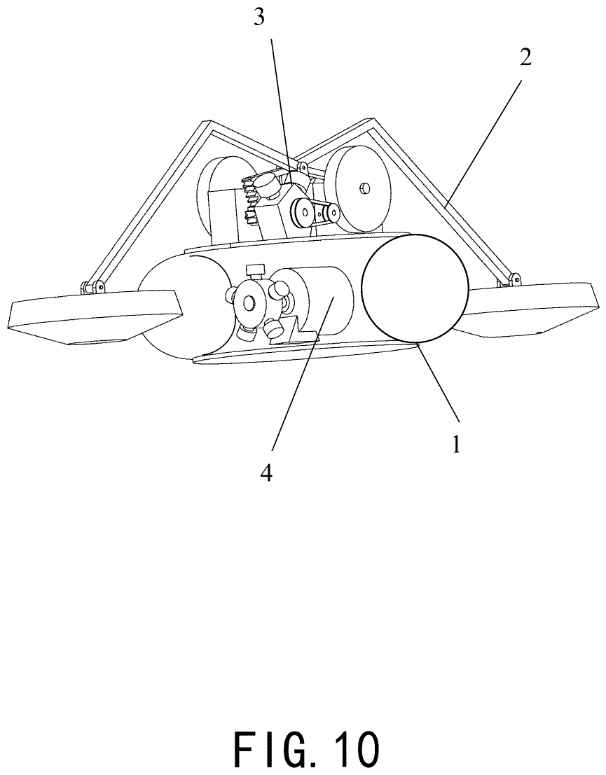

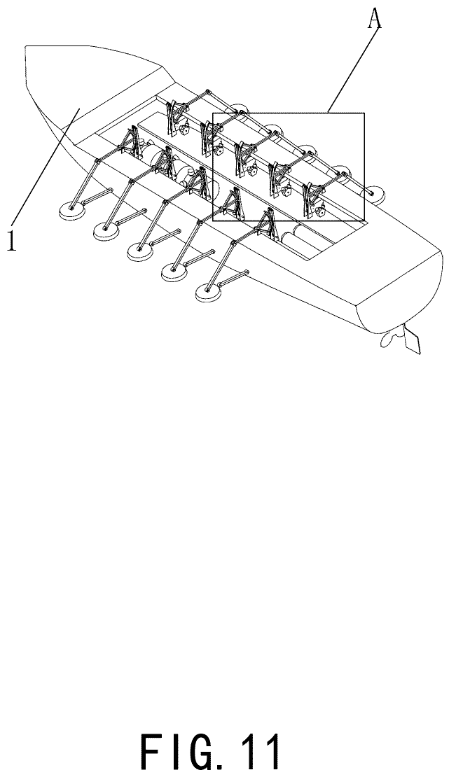

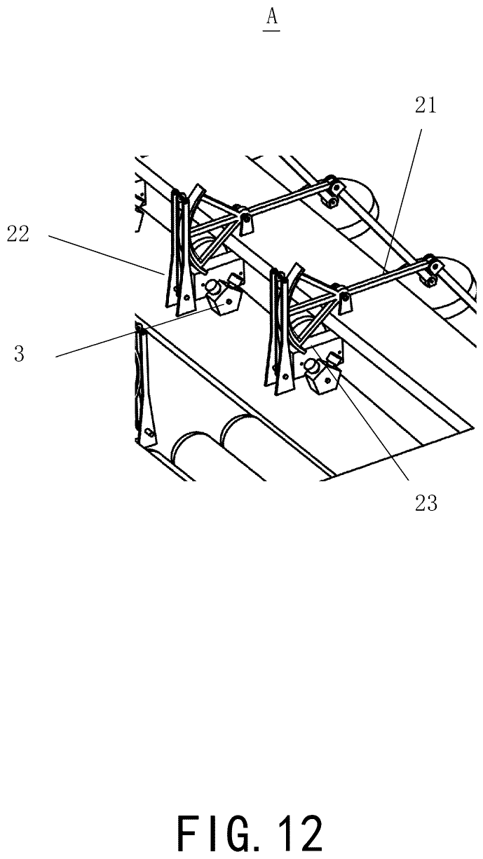

Further, besides the above-mentioned arrangement forms, the working platform 1 further comprises other forms. Specifically, as shown in FIG. 10, in some embodiments of the present application, the wave energy power generation device of the present application is used for a navigation light by a single set. The navigation light is used as the working platform 1 at this time; the wave energy conversion mechanism 2, the wave energy storage mechanism 3 and the wave energy power generation mechanism 4 are all arranged in a bottom shell of the navigation light. Further, as shown in FIG. 11 and FIG. 12, in other embodiments of the present application, a plurality of sets of wave energy power generation devices are combined and arranged on a power generation ship. At this time, the power generation ship is used as the working platform 1; and the wave energy conversion mechanism 2, the wave energy storage mechanism 3 and the wave energy power generation mechanism 4 are all arranged on a ship hull.

Obviously, the wave energy power generation device of the present application can be used alone, or arranged in multiple sets to form modular units for array use. The formed modular unit can also be used alone or several sets of the modular units can be arranged to form a modular matrix according to design requirements.

In addition, the present invention further provides a wave energy power generation method based on a wave energy power generation device, which comprises the following steps:
S1: arranging a buoyancy tank on a sea surface; floating, by the buoyancy tank, up and down with wave fluctuation; driving a lever to rotate around a fulcrum by floating of the buoyancy tank; and swinging, by a swing head at the other end of the lever, up and down with rotation of the lever;
S2: driving a first driving wheel of a transmission assembly to rotate by swing of the swing head; and driving a first driven wheel to rotate by rotation of the first driving wheel;
S3: driving an input gear and an output gear to rotate by rotation of the first driven wheel; and driving, by rotation of the input gear and the output gear, a flywheel to rotate through a unidirectional gear set;
S4: driving a second driving wheel to rotate by rotation of the flywheel; and driving a second driven wheel to rotate by rotation of the second driving wheel;
S5: driving an air compressor to operate by rotation of the second driven wheel; compressing air; and transmitting the compressed high-pressure gas to a high-pressure gas storage tank through a ventilation pipe;
S6: transporting the high-pressure gas storage tank to an air turbine through the ventilation pipe to drive the air turbine to operate; and driving, by the operation of the air turbine, a generator to operate to complete power generation.

To sum up, the present invention provides a wave energy power generation device, which comprises the working platform, and the wave energy conversion mechanism, the wave energy storage mechanism and the wave energy power generation mechanism, which are arranged on the working platform. By means of the structures, such as the buoyancy tank, the lever, the gear set and the flywheel, the wave energy conversion mechanism converts wave energy, which is contained in continuously fluctuating waves, into mechanical energy ensuring the continuous rotation of the flywheel step by step; and the wave energy storage mechanism, by means of compressed gas, collects and stores the wave energy converted into the mechanical energy. Compared with the prior art, the wave energy power generation device realizes the effective utilization of the wave energy, and is ingenious in structural design. By means of the provision of the buoyancy tank and the lever, the energy generated by the heave motion of the buoyancy tank due to up-and-down floating can be effectively collected; rolling and pitching of the buoyancy tank are effectively reduced; the energy loss caused by the rolling and pitching of the buoyancy tank is avoided; and the energy conversion efficiency is improved. The wave energy storage mechanism converts the generated mechanical energy into the internal energy of high-pressure gas, and then releases the high-pressure gas to drive the air turbine and the generator to operate, such that the generator can be persistently and stably supplied with energy, thereby ensuring the stable operation of the generator. The device can be used alone or combined in multiple sets to form a modular unit according to use requirements, which can be miniaturized or enlarged, and has a wide application range. The device can be designed into various kinds of power generation equipment according to needs, and has long-term benefits by one-time investment.

The above only describes preferred implementations of the present invention. It should be pointed out that for those ordinary skilled in the art, several improvements and modifications can be made without departing from the principle of the present invention, which should also be regarded as the protection scope of the present invention.

What is claimed is:

1. A wave energy power generation device, comprising a working platform, and a wave energy conversion mechanism, a wave energy storage mechanism and a wave energy power generation mechanism, which are arranged on the working platform;
wherein the wave energy conversion mechanism comprises an energy conversion assembly and a conversion assembly;
the energy conversion assembly comprises a buoyancy tank, a lever and a first bracket; the buoyancy tank is arranged on a sea surface and is hinged with one end of the lever; a fulcrum of the lever is hinged with the first bracket; the other end of the lever is fixedly connected with an arc-shaped swing head; and the arc surface circle center of the swing head coincides with the fulcrum of the lever;
the conversion assembly comprises an input shaft, an output shaft and a transition shaft; the input shaft is sleeved with an input gear; the output shaft is sleeved with a first unidirectional gear, a second unidirectional gear, a flywheel and an output gear; the transition shaft is sleeved with a transition gear set; the input gear is in transmission connection with the swing head through a transmission assembly; the input gear is in transmission connection with the first unidirectional gear; the input gear is in transmission connection with the second unidirectional gear through the transition gear set; the first unidirectional gear and the second unidirectional gear can drive the output shaft to rotate under drive of the input gear, and drive the output shaft to rotate in the same direction; and the output gear and the flywheel can rotate together with the output shaft;
the wave energy storage mechanism comprises an air compressor and a high-pressure gas storage tank; the air compressor is in transmission connection with the output gear through a connecting assembly; and the air compressor is connected to the high-pressure gas storage tank through a ventilation pipe;
the wave energy power generation mechanism comprises an air turbine and a generator; the air turbine is connected to the high-pressure gas storage tank through the ventilation pipe; and
the air turbine is in transmission connection with the generator.

2. The wave energy power generation device according to claim 1, wherein the buoyancy tank is hinged with the lever through a first connecting rod; and the buoyancy tank is hinged with the first bracket through a second connecting rod.

3. The wave energy power generation device according to claim 2, wherein the energy conversion assembly further comprises a sliding rail arranged on the working platform and an electric hoist arranged on the sliding rail, and the electric hoist is connected to the first connecting rod through a steel wire rope.

4. The wave energy power generation device according to claim 1, wherein the transmission assembly comprises a first sprocket, a second sprocket, a first driving wheel and a first driven wheel; the first sprocket is in transmission connection with the second sprocket through a chain; two ends of the chain are crossed and then arranged at two ends of an arc top of the swing head respectively; the first driving wheel and the first sprocket are arranged on the same rotating shaft and can rotate under drive of the first sprocket; the first driven wheel is in transmission connection with the first driving wheel through a first conveyor belt; and the first driven wheel is in transmission connection with the input gear.

5. The wave energy power generation device according to claim 1, wherein a rack is arranged on the arc surface of the swing head; the transmission assembly comprises a meshing gear, a first driving wheel and a first driven wheel; the meshing gear is meshed with the rack; the first driving wheel and the meshing gear are arranged on the same rotating shaft and can rotate under drive of the meshing gear; the first driven wheel is in transmission connection with the first driving wheel through a first conveyor belt; and the first driven wheel is in transmission connection with the input gear.

6. The wave energy power generation device according to claim 1, wherein the conversion assembly is provided with a speed-increasing gear set; the speed-increasing gear set comprises a first speed-increasing gear and a second speed-increasing gear meshed with each other; the first speed-increasing gear is in transmission connection with the transmission assembly; the second speed-increasing gear is in transmission connection with the input gear; and the diameter of the first speed-increasing gear is larger than the diameter of the second speed-increasing gear.

7. The wave energy power generation device according to claim 1, wherein the conversion assembly is provided with a reduction gear set; the reduction gear set comprises a first reduction gear and a second reduction gear meshed with each other; the first reduction gear is in transmission connection with the output gear; the second reduction gear is in transmission connection with the connecting assembly; and the diameter of the first reduction gear is smaller than the diameter of the second reduction gear.

8. The wave energy power generation device according to claim 6, wherein the conversion assembly is provided with a reduction gear set; the reduction gear set comprises a first reduction gear and a second reduction gear meshed with each other; the first reduction gear is in transmission connection with the output gear; the second reduction gear is in transmission connection with the connecting assembly; and the diameter of the first reduction gear is smaller than the diameter of the second reduction gear.

9. The wave energy power generation device according to claim 1, wherein the connecting assembly comprises a second driving wheel and a second driven wheel; the second driving wheel is in transmission connection with the output gear; and the second driven wheel is sleeved on an output shaft of the air compressor and is in transmission connection with the second driving wheel through a second conveyor belt.

10. The wave energy power generation device according to claim 1, wherein the wave energy storage mechanism further comprises an air filter connected to the air compressor.

11. The wave energy power generation device according to claim 1, wherein the high-pressure gas storage tank comprises a primary gas storage tank, a secondary gas storage tank and a tertiary gas storage tank which are sequentially arranged.

12. A wave energy power generation method, comprising the following steps:
S1: arranging a buoyancy tank on a sea surface; floating, by the buoyancy tank, up and down with wave fluctuation; driving a lever to rotate around a fulcrum by floating of the buoyancy tank; and swinging, by a swing head at the other end of the lever, up and down with rotation of the lever;
S2: driving a first driving wheel of a transmission assembly to rotate by swing of the swing head; and driving a first driven wheel to rotate by rotation of the first driving wheel;
S3: driving an input gear and an output gear to rotate by rotation of the first driven wheel; and driving, by rotation of the input gear and the output gear, a flywheel to rotate through a unidirectional gear set;
S4: driving a second driving wheel to rotate by rotation of the flywheel; and driving a second driven wheel to rotate by rotation of the second driving wheel;
S5: driving an air compressor to operate by rotation of the second driven wheel; compressing air; and transmitting the compressed high-pressure gas to a high-pressure gas storage tank through a ventilation pipe;
S6: transporting the high-pressure gas storage tank to an air turbine through the ventilation pipe to drive the air turbine to operate; and driving, by the operation of the air turbine, a generator to operate to complete power generation.
